(19) United States
(12) Patent Application Publication
(10) Pub. No.: US 2009/0307186 A1
(43) Pub. Date: Dec. 10, 2009

(54) Method and Apparatus for Database Management and Program

(75) Inventors: Akiko HOSHINO, Yokohama (JP); Norihiro HARA, Kawasaki (JP); Shota KUMAGAI, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/368,393

(22) Filed: Feb. 10, 2009

(30) Foreign Application Priority Data
Jun. 6, 2008 (JP) 2008-149405

(51) Int. Cl. G06F 17/30

(52) U.S. Cl. 707/2; 707/E17.005; 707/E17.002; 707/E17.05; 707/E17.017

(57) ABSTRACT

A database management apparatus including an auxiliary storage unit for storing structured data and a database management part for managing the structured data, which extracts all paths showing a storage position of the structured data to be processed from an SQL statement for processing the structured data; when a plurality of the paths are extracted, the database management apparatus compares the extracted paths with each other, and extracts as a common path a common part of both the paths; and processes using the SQL statement the structured data of nodes of the storage position or lower shown by the extracted common path.

### INCORPORATION BY REFERENCE

The present application claims priority from Japanese application JP2008-149405 filed on Jun. 6, 2008, the content of which is hereby incorporated by reference into this application.

### BACKGROUND OF THE INVENTION

The present invention relates to a database management technology.

For one way to share various pieces of information in electronic commerce between companies, electronic application system, and electronic clinical chart system at present, there is increasing a chance to store in a database XML (extensible Markup Language) data that is characterized in convenience or expandability. Further, in the XML data, XPath disclosed in W3C (World Wide Web Consortium) Recommendation is a path language indicating a specified part of the XML data, and plays an important role in inquiries to the XML data.

To process the XPath, nodes with a tree structure are followed in the order corresponding to route nodes. Accordingly, in the process following the tree structure, all the nodes are followed in sequence except for a case where nodes can be specified by indexes. Therefore, it takes time to do a search depending on the specification of the XPath and the tree structure.

The XML data is directly stored as column data in a DBMS (DataBase Management System) and a trend of using a conventional resource RDBMS (Relational DBMS) also becomes widespread. On the occasion when the XML column of the RDBMS is searched, a technology of using SQL/XML is adopted (see, e.g., Jim Melton and Stephen Buxton, “Querying XML-XQuery, XPath, and SQL/XML in Context”, Morgan Kaufmann Publishers, 523-582, 2006).

In a mechanism of the search of the conventional RDBMS, input SQL statements are first decomposed into a select expression, a table expression, and a search-condition. Further, a table shown in the table expression is accessed to specify a table of structured data, whether a predetermined element is included in this structured data is determined using the search-condition, a process specified to the select expression is performed with regard to the structured data including the predetermined element, and obtained results are returned to an application requiring the search.

### SUMMARY OF THE INVENTION

However, when a plurality of XPaths are specified in SQL statements towards the same XML data, XPaths with relativity are included in the plurality of XPaths in many cases. For example, when data fields of specified rows in a table expression are narrowed using the XPath of a search-condition and one specified part is projected from among the narrowed data fields using the XPath of a select expression, the relativity is present in the XPath of the search-condition, the XPath of the table expression, and the XPath of the select expression.

In the technology of the conventional RDBMS, even if the XPath with relativity among the select expression, the table expression, and the search-condition is present, each process in the select expression, the table expression, and the search-condition is performed in separate step. Accordingly, a common XPath must be evaluated more than once. Therefore, as it takes more time to evaluate a complicated XPath, it takes more time to conduct a search.

In view of the foregoing, it is an object of the present invention to provide a database management method, database management apparatus, and program capable of shortening a search time of structured data.

To accomplish the above objects, the database management method, database management apparatus, and program according to the present invention extract all paths showing a storage position of data to be processed from the SQL statement for processing the structured data; when a plurality of the paths are extracted, compare the extracted paths with each other, and extract as a common path a common part of both the paths; and process using the SQL statement the data of nodes of the storage position or lower shown by the extracted common path in the structured data stored in the storage part.

According to the present invention, there can be provided the database management method, database management apparatus, and program which can exclude a process from a route node up to a node shown by a common path and which can shorten a search time of the structured data.

Other objects, features and advantages of the invention will become apparent from the following description of the embodiments of the invention taken in conjunction with the accompanying drawings.

### BRIEF DESCRIPTION OF THE DRAWINGS

FIG. 1 is a functional block diagram showing a configuration of a database management system according to the present embodiment of the present invention.

FIG. 2 shows one example of an SQL statement supplied to a database management apparatus according to the present embodiment.

FIGS. 3A and 3B show one example of an XML schema according to the present embodiment.

FIGS. 4A and 4B show one example of index constituent information according to the present embodiment.

FIG. 5 shows one example of access cost setting information according to the present embodiment.

FIGS. 6A and 6B show one example of data storage position information according to the present embodiment.

FIG. 7 is a flowchart showing a flow of a process of a database management method according to the present embodiment.

FIGS. 8A and 8B show examples where hint information is included in an SQL statement supplied to the database management apparatus according to the present embodiment.

FIG. 9 illustrates using a tree structure a common XPath according to the present embodiment.

FIG. 10 describes a determination of an access plan in which an access cost is minimized in the database management method according to the present embodiment.

FIG. 11 is a flowchart showing a flow of a process of an XPath in a search-condition and select expression using an XLM schema in the database management method according to the present embodiment.

FIG. 12 is a flowchart showing a flow of a process of an XPath in a table expression using an XLM schema in the database management method according to the present embodiment.

FIG. 13 is a flowchart showing a flow of a process of an XPath in the search-condition and select expression using index constituent information in the database management method according to the present embodiment.

FIG. 14 is a flowchart showing a flow of a process of an XPath in the table expression using index constituent information in the database management method according to the present embodiment.

FIG. 15 is a flowchart showing a flow of a process in which a common XPath is extracted in the database management method according to the present embodiment.

FIG. 16 is a flowchart showing a flow at the time of determining an access plan using a common XPath in the database management method according to the present embodiment.

FIGS. 17A and 17B describe a concept for performing an SQL according to an access plan in the database management method according to the present embodiment.

FIG. 18 is a flowchart showing a flow at the time of accessing a database in the database management method according to the present embodiment.

FIG. 19 is a flowchart showing a flow at the time of evaluating the search-condition in the database management method according to the present embodiment.

FIG. 20 is a flowchart showing a flow at the time of evaluating an XPath of the select expression in the database management method according to the present embodiment.

### DESCRIPTION OF THE EMBODIMENTS

Hereinafter, preferred embodiments of the present invention will be suitably described in detail with reference to the accompanying drawings.

In the present invention, structured data includes XML data and SGML (Standard Generalized Markup Language) data, and in the present embodiment, the XML data will be described as an example.

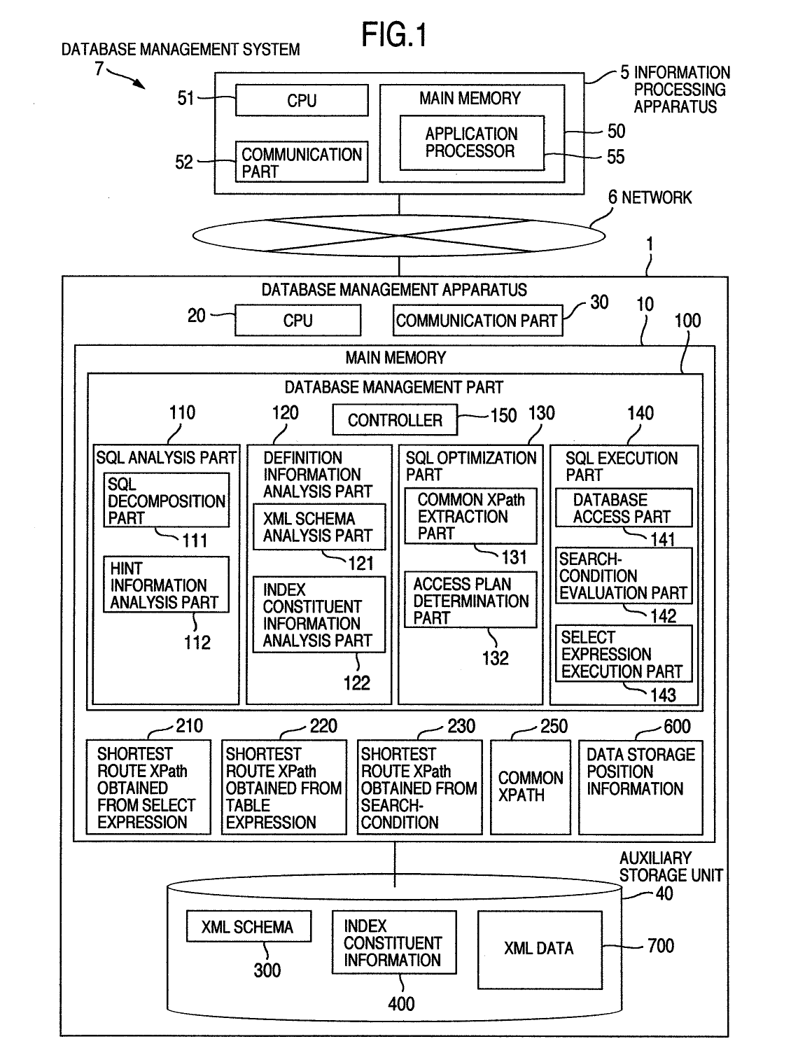

FIG. 1 is a functional block diagram showing a configuration example of a database management system according to the present embodiment. As shown in FIG. 1, a database management system 7 includes an information processing apparatus 5 and a database management apparatus 1 that is connected communicably to the information processing apparatus 5 via a network 6.

The information processing apparatus 5 here includes a main memory 50, a CPU (Central Processing Unit) 51, and a communication part 52. In the main memory 50, an application processor 55 that controls an application program is read as a program and processed via the CPU 51. When this application processor 55 inquires XML data to the database management apparatus 1, an inquiry request is transmitted to the database management apparatus 1 through the communication part 52 via the network 6.

The database management apparatus 1 includes a main memory 10, a CPU 20, a communication part 30, and an auxiliary storage unit 40.

The CPU 20 performs control and operation of the entire database management apparatus 1. The communication part 30 receives data such as SQL statements from the information processing apparatus 5 via the network 6.

The auxiliary storage unit 40 includes storage parts such as a flash memory and a hard disk, and stores XML data 700, XML schema 300, and index constituent information 400 described below.

The main memory 10 includes a primary storage device such as a RAM (Random Access Memory), and in the memory 10, a database management part 100 is read as programs. Further, the main memory 10 temporarily stores common XPath 250 and data storage position information 600 (details will be described below) processed by the database management part 100.

The database management part 100 performs control relating to a process of the XML data 700 stored in the auxiliary storage unit 40, and includes an SQL analysis part 110, a definition information analysis part 120, an SQL optimization part 130, an SQL execution part 140, and a controller 150. In addition, the database management part 100 is realized, for example, when the CPU 20 develops into the main memory 10 a program stored in the auxiliary storage unit 40 provided on the database management apparatus 1 to execute the program.

The SQL analysis part 110 analyzes SQL statements obtained from the application processor 55 of the information processing apparatus 5 through the communication part 30. This SQL analysis part 110 includes an SQL decomposition part 111 and a hint information analysis part 112.

The SQL decomposition part 111 decomposes the obtained SQL statement into a select expression, a table expression, and a search-condition. The SQL statement used in a search process of the XML data 700 can include at least the table expression specifying a table of the XML data 700 and the select expression projecting the XML data 700 from among predetermined elements, and further the search-condition taking out a specified row from among the XML data fields 700 to be processed.

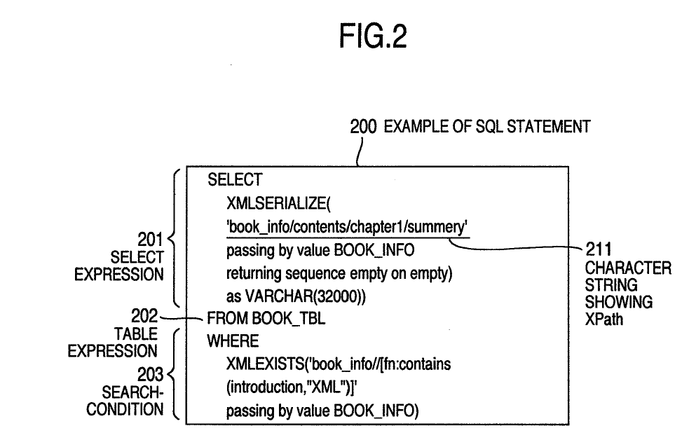

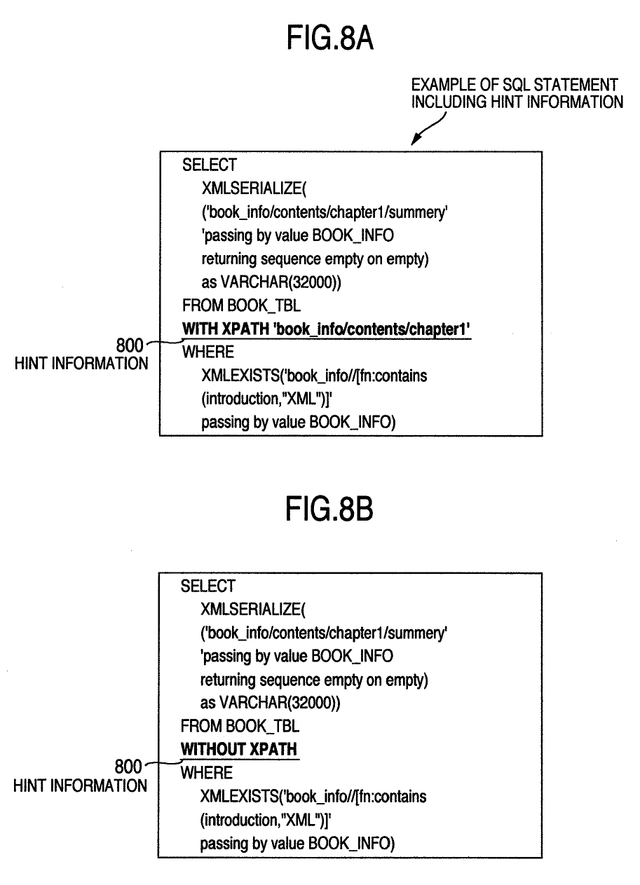

FIG. 2 shows one example of an SQL statement obtained by the SQL analysis part via the network from the application processor of the information processing apparatus in FIG. 1. As shown in FIG. 2, an SQL statement 200 includes a select expression 201 specified by a SELECT phrase, a table expression 202 specified by a FROM phrase, and a search-condition 203 specified by a WHERE phrase. Further, the SQL statement 200 can include hint information described below in addition to the select expression 201, the table expression 202, and the search-condition 203. In addition, this hint information is information that specifies whether the SQL statement is processed using the common XPath 250, and the details will be described below (see FIG. 8).

Returning to FIG. 1, the hint information analysis part 112 analyzes whether the hint information that specifies whether the process is performed using the common XPath 250 described below is included in the SQL statement. Further, if the hint information is included in the SQL statement, the part 112 determines whether the XML data 700 is processed using the common XPath 250 according to the instruction.

Next, the definition information analysis part 120 segments from the SQL statement decomposed by the SQL decomposition part 111 a character string showing the XPath specifying a storage position of the data to be processed. Based on the XML schema 300 or index constituent information 400 described below, the part 120 obtains the shortest route XPath from the route node up to the storage position of the data to be processed. In the present example, the shortest route is used as an example; however, the present invention is not necessarily limited to the shortest route and the effect of shorter route is exerted. The route is stored and used to thereby shorten the search execution time. This part 120 includes the XML schema analysis part 121 and the index constituent information analysis part 122.

The XML schema analysis part 121 segments the character string showing the XPath from the SQL statement. When each segmented character string showing the XPath is specified by the abbreviated description method, the part 121 converts the above description method into the full path description method, and when each character string is specified by the description method of reverse document order, the part 121 converts the above description method into the description method of document order. Further, the part 121 compares the converted character string showing the XPath and the XML schema 300 stored in the auxiliary storage unit 40 in sequence from the route node up to the node specified by the XPath. The part 121 obtains the shortest route XPath 210 obtained from the select expression, the shortest route XPath 220 obtained from the table expression, and the shortest route XPath 230 obtained from the search-condition and stores them in the main memory 10.

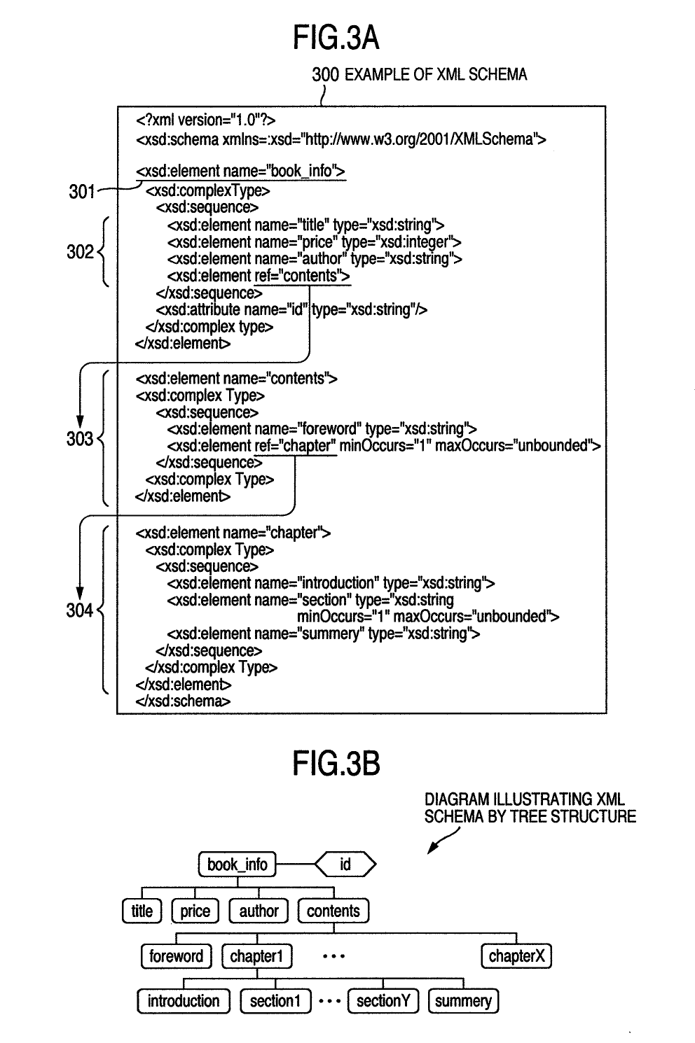

FIGS. 3A and 3B show one example of the XML schema stored in the auxiliary storage unit of FIG. 1. As shown in FIG. 3A, a configuration of the XML document is defined by the XML schema 300. For example, in the definition sentence shown in the code 301, an element of the route node is declared to be “book_info”, and further in the definition sentence shown in the code 302, “book_info” is declared to have “title”, “price”, “author”, and “contents” as a child element. The elements of “contents” are further declared using a reference attribute and the definition sentence shown in the code 303 is described as a reference destination. In the definition sentence, “contents” are declared to have “foreword” and “chapter” as the child element. Further, the definition sentence shown in the code 304 is described, and “chapter” is declared to have “introduction”, “section”, and “summary” as the child element.

FIG. 3B illustrates contents defined by the XML schema of FIG. 3A using a tree structure. When the XML schema 300 is developed into the main memory 10, elements can be searched from the route node up to the node specified by the XPath. Accordingly, the XML schema analysis part 121 compares a character string showing the XPath included in the select expression, the table expression, and the search-condition and the XML schema 300 from the route node up to the node specified by the XPath in the order corresponding to documents, thereby specifying the shortest route XPath.

Returning to FIG. 1, the index constituent information analysis part 122 segments the character string showing the XPath from the SQL statement. Each segmented character string showing the XPath, when specified by the abbreviated description method, is converted from the above description method to the full path description method. Alternatively, the character string, when specified by the description method of reverse document order, is converted from the above description method to the description method of document order. Further, the index constituent information analysis part 122 compares the converted character string showing the XPath and the index constituent information 400 stored in the auxiliary storage unit 40 from the route node up to the node specified by the XPath in the order corresponding to document order. Further, the part 122 obtains the shortest route XPath 210 obtained from the select expression, the shortest route XPath 220 obtained from the table expression, and the shortest route XPath 230 obtained from the search-condition to store them in the main memory 10.

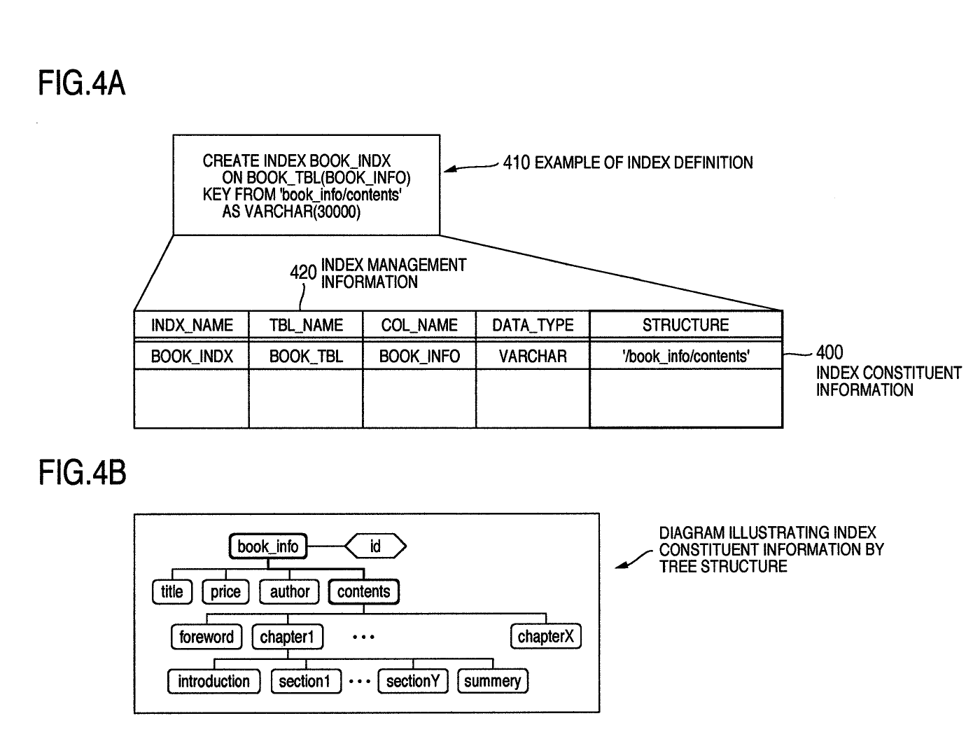

FIGS. 4A and 4B show one example of the index constituent information stored in the auxiliary storage unit of FIG. 1. FIG. 4A shows one example of the index constituent information according to the present embodiment. FIG. 4B illustrates using the tree structure one example of the index constituent information shown in FIG. 4A. As shown in FIG. 4A, when the index definition is specified, the database management part 100 generates index management information 420 from the index definition 410. This index management information 420 includes the XPath (hereinafter, referred to as the index constituent information 400) for identifying a key specified at the time of the index definition along with an index name (INDX_NAME), a table name (TBL_NAME), a column name (COL_NAME), and a data type (DATA_TYPE), and is stored in the auxiliary storage unit 40.

FIG. 4B illustrates using the tree structure a content of the XPath identifying an index key, for example, when the index constituent information 400 is ‘/book_info/contents’. When the index constituent information 400 is developed into the main memory 10 of FIG. 1, the element can be searched from the route node up to the node specified by the XPath. Accordingly, even when the XML schema 300 is not stored in the auxiliary storage unit 40, the index constituent information analysis part 122 compares the character string showing the XPath obtained from the select expression, the table expression, and the search-condition with the tree structure defined by the index constituent information 400 from the route node up to the node specified by the XPath in the order corresponding to document order, thereby identifying the shortest route XPath.

Returning to FIG. 1, the SQL optimization part 130 extracts common parts as the common XPath 250 from the character string showing the shortest route XPath each obtained from the select expression, the table expression, and the search-condition extracted by the definition information analysis part 120 and determines an access plan using the extracted common XPath 250. This SQL optimization part 130 includes a common XPath extraction part 131 and an access plan determination part 132.

The common XPath extraction part 131 reads the shortest route XPath 230 obtained from the search-condition, the shortest route XPath 210 obtained from the select expression, and the shortest route XPath 220 obtained from the table expression which are stored in the main memory 10, and compares both of the XPaths with each other from the lower node up to the route node. At this time, the part 131 may compare both of the XPaths with each other in sequence from the route node up to the lower node. As a result of the above comparison, the part 131 stores the XPath coincident with each other as the common XPath 250 in the main memory 10.

The access plan determination part 132 determines as the access plan an access plan in which the access cost is minimized using the common XPath 250 extracted by the common XPath extraction part 131. The access plan according to the present embodiment (also referred to as a “query plan”) means a procedure for performing an XPath evaluation of the table expression, an XPath evaluation of the search-condition, a row ID return, a data storage position information return shown by the common XPath 250, data acquisition based on the row ID, data acquisition of the node or lower shown by the common XPath 250 based on the data storage position information 600, and an XPath evaluation of the select expression. In the present embodiment, the XPath evaluation of the table expression means that a table of the structured data is accessed based on the table expression in the SQL statement. The XPath evaluation of the search-condition means that “true” or “false” is determined whether a predetermined element shown in the search-condition satisfies conditions. Further, the XPath evaluation of the select expression means that whether predetermined elements shown by the select expression are included in the structured data developed into the main memory is determined.

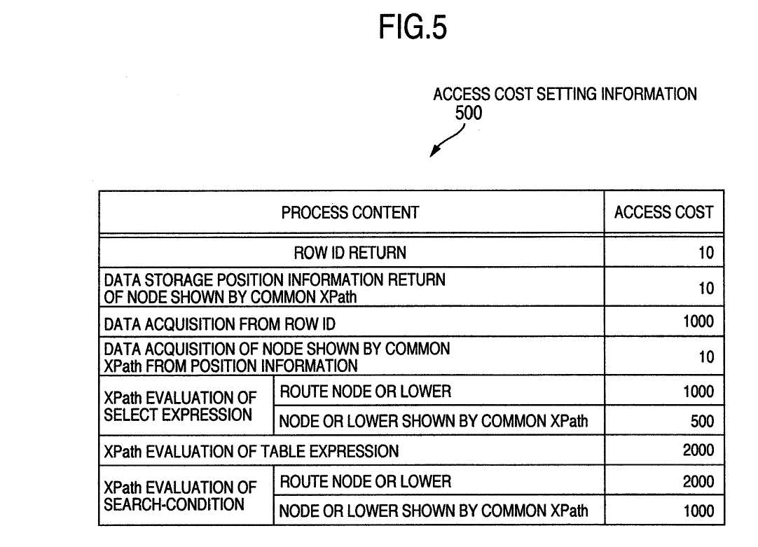

FIG. 5 shows one example of the access cost setting information showing the access cost of each process according to the present embodiment. As shown in FIG. 5, each access cost shown by this access cost setting information 500 is previously set, for example, with a relative value corresponding to the process time required to perform the process contents. For example, with regard to the access cost required for the XPath evaluation of the table expression and that of the search-condition of the route node or lower, the auxiliary storage unit 40 is accessed to perform the condition evaluation, and therefore, a relatively large value is set at “2000”. Meanwhile, when the node or lower shown by the common XPath 250 is evaluated, the access cost required for the XPath evaluation of the search-condition as well as for that of the select expression is set to be reduced as compared with the case where the route node or lower is evaluated. The reason is that there is a possibility that when the common XPath 250 is used, the access cost can be reduced according to the number of nodes capable of omitting the evaluation. The access cost required for the XPath evaluation of the select expression is performed using data stored in the main memory 10, and therefore, set to be reduced as compared with the access cost required for the XPath evaluation of the table expression and for that of the search-condition. Since the data length is short as compared with the data acquisition from the row ID, the access cost required for the row ID return and for the data storage position information return of the node shown by the common XPath 250 is set to be extremely reduced. With regard to the data acquisition of the node shown by the common XPath 250 from the position information, since the data stored in the main memory 10 is used, the access cost is set to be reduced. The access cost is calculated by summing up each access cost that is thus set. Among the combinations of the common XPath 250, an access plan in which the access cost is minimized is determined as the access plan.

Returning to FIG. 1, the SQL execution part 140 performs an SQL based on the access plan determined by the access plan determination part 132. The part 140 includes the database access part 141, the search-condition evaluation part 142, and the select expression execution part 143.

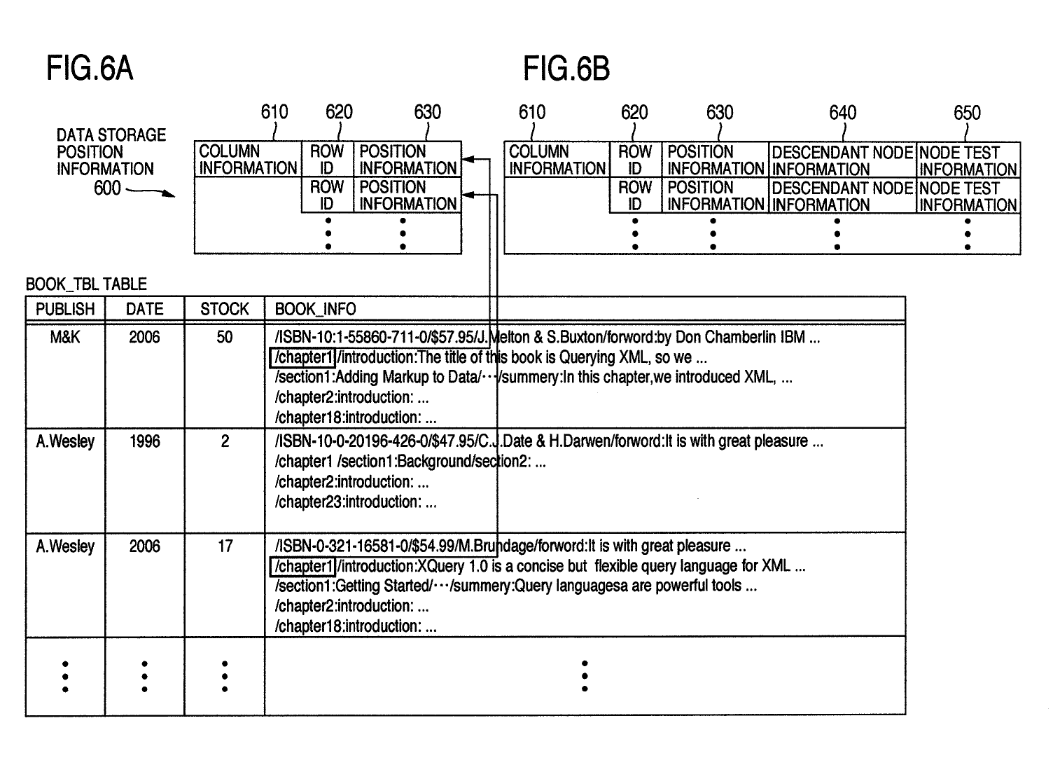

The database access part 141 specifies a table to be operated among the XML data fields 700 stored in the auxiliary storage unit 40 (e.g., ‘BOOK_TBL’ specified by the table expression 202 of FIG. 2). Further, the search-condition evaluation part 142 evaluates the search-condition of the data shown by a table, obtains the row ID of a row in which the evaluation of the search-condition is true and the position information of nodes shown by the common XPath 250, and stores in the main memory 10 the data storage position information 600 (for details, refer to FIG. 6 described below) shown by the common XPath 250.

The select expression execution part 143 obtains data from the row ID stored in the data storage position information 600 and stores the data in the main memory 10. Using the position information stored in the data storage position information 600, the part 143 obtains the data of the node or lower shown by the common XPath 250 from the data developed into the main memory 10. After that, the part 143 does not evaluate data from the route node up to the node shown by the common XPath 250, but evaluates data of the node or lower showing an XPath of the select expression by the common XPath 250.

FIGS. 6A and 6B show examples of the data storage position information according to the present embodiment. FIG. 6A shows an example in which the column information, the row ID, and the position information are included as the data storage position information. FIG. 6B shows an example in which the descendant node information and the node test information are further included as the data storage position information. As shown in FIG. 6A, the data storage position information 600 includes the column information 610 for identifying a column in which the common XPath 250 is specified, the row ID 620 for identifying a row in which the evaluation of the search-condition is true, and the position information 630 of data shown by the common XPath 250. Similarly, the data storage position information 600 in the case of being obtained at the time of the XPath evaluation of the table expression includes the column information 610 for identifying a column in which the common XPath 250 is specified, the row ID 620 for identifying a row in which the evaluation of the search-condition is true, and the position information 630 of data shown by the common XPath 250.

Further, as shown in FIG. 6B, this data storage position information 600 can include the descendant node information 640 as information discriminating the presence or absence of the descendant node of nodes shown by the common XPath 250 and the node test information 650 as information showing whether the node coincides with the node test in addition to the column information 610, the row ID 620, and the position information 630 of the data shown by the common XPath 250.

Only when the descendant node is present in the node shown by the common XPath 250, the search-condition evaluation part 142 and the select expression execution part 143 evaluate the XPath by using this descendant node information 640. Accordingly, the part 142 and the part 143, when determining that the descendant node is absent, do not evaluate the XPath. That is, the part 142 performs a process in which the condition determination is false, and the part 143 performs a process in which NULL is returned.

When using the node test information 650 showing whether the node shown by the common XPath 250 coincides with the node test, only in the case when the node coincides with the node test, the search-condition evaluation part 142 and the select expression execution part 143 evaluate the XPath. When the node does not coincide with the node test, the part 142 performs a process in which the condition determination is false, and the part 143 performs a process in which NULL is returned.

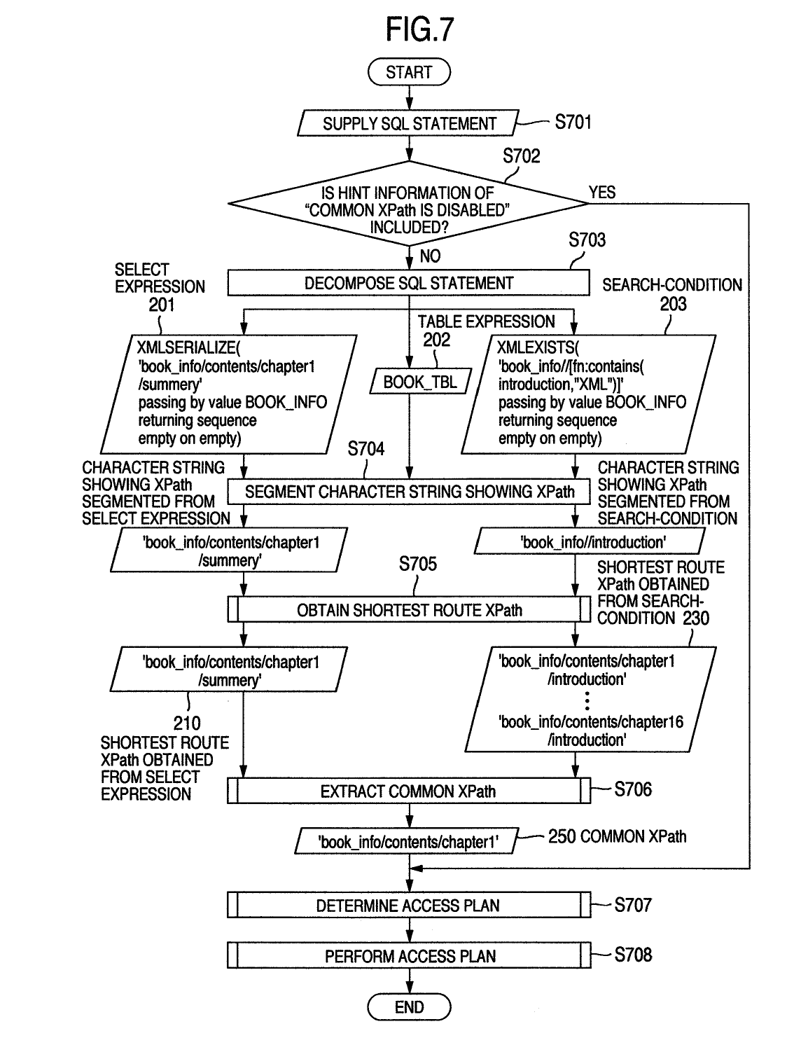

Next, a process of the database management method according to the present embodiment will be described along FIG. 7 with reference to FIG. 1. FIG. 7 shows an example of a process from the supply of an SQL statement up to the preparation of an access plan in which an access cost is minimized. In FIG. 7, a description will be made on the premise that the SQL statement 200 shown in FIG. 2 is supplied to the database management apparatus 1.

At first, the SQL statement 200 is supplied to the database management apparatus 1 via the network 6 through the application processor 55 of the information processing apparatus 5 (see FIG. 1) (step S701). When the SQL statement 200 is supplied to the database management apparatus 1, the hint information analysis part 112 first determines whether hint information of “the common XPath is disabled” is included in the SQL statement 200 (step S702). If the hint information of “the common XPath is disabled” is not included in the SQL statement 200 (step S702: No), the process goes to step S703. Meanwhile, if the hint information of “the common XPath is disabled” is included in the SQL statement 200 (step S702: Yes), the process goes to step S707 and a determination processing of the access plan is performed.

FIGS. 8A and 8B show examples of the SQL statements in which the hint information specifying whether to use the common XPath is included. FIG. 8A shows an example of including the hint information indicating that the common XPath is used. FIG. 8B shows an example of including the hint information indicating that the common XPath is not used.

In the SQL statement shown in FIG. 8A, a “with xpath phrase” is specified as the hint information 800. This “with xpath phrase” indicates that the common XPath 250 previously specified by this hint information 800 is used to prepare the access plan. In an example of FIG. 8A, ‘book_info/contents/chapter1’ is specified as the common XPath 250. When the use of the common XPath 250 is thus indicated by the hint information 800, the access plan determination part 132 determines an access plan using the specified common XPath 250 regardless of a minimum access cost.

In doing so, when the common XPath 250 is previously known, the SQL execution part 140 (see FIG. 1) can search the XML data 700 using the common XPath 250 specified by the hint information 800.

Meanwhile, in the SQL statement shown in FIG. 8B, a “withOUT xpath phrase” is specified as the hint information 800. This “withOUT xpath phrase” indicates that the common XPath 250 is not used. By the indication of this hint information 800, the access plan determination part 132 determines an access plan without using the common XPath 250 regardless of the minimum access cost.

The “with xpath phrase” and “withOUT xpath phrase” as the hint information 800 shown in FIGS. 8A and 8B are one example of specifying whether to use the common XPath 250, and whether to use the common XPath 250 may be specified by another description method.

With regard to the hint information 800 shown in FIGS. 8A and 8B, a user can specify whether to use the common XPath 250 in units of the SQL statement. For example, from the application processor 55 of the information processing apparatus 5, the database management part 100 obtains the hint information in units of the application or the database management system. When the XML data 700 is inquired, the hint information analysis part 112 can also determine whether the process is performed using the common XPath 250 according to the hint information. With regard to the hint information in units of the application or the database management system, the hint information analysis part 112 within the database management part 100 can set whether to use the common XPath 250. By setting the above, the access plan determination part 132 can determine the access plan using the common XPath 250 regardless of the minimum access cost. Alternatively, the part 132 can determine the access plan without using the common XPath 250 regardless of the minimum access cost.

By doing so, when the common XPath 250 need not be used, or when the access cost is not apparently reduced even using the common XPath 250, the user can set using the hint information 800 a process in which the common XPath 250 is not used.

Returning to FIG. 7, in step S702, when the hint information 800 of “the common XPath is disabled” is not included in the SQL statement 200 (step S702: No), the SQL decomposition part 111 decomposes the supplied SQL statement 200 into the select expression 201, the table expression 202, and the search-condition 203 (step S703). When the hint information 800 of “the common XPath is enabled” is included in the SQL statement 200, or also when the hint information 800 itself is not included in the SQL statement 200, a process of (step S702: No) is performed.

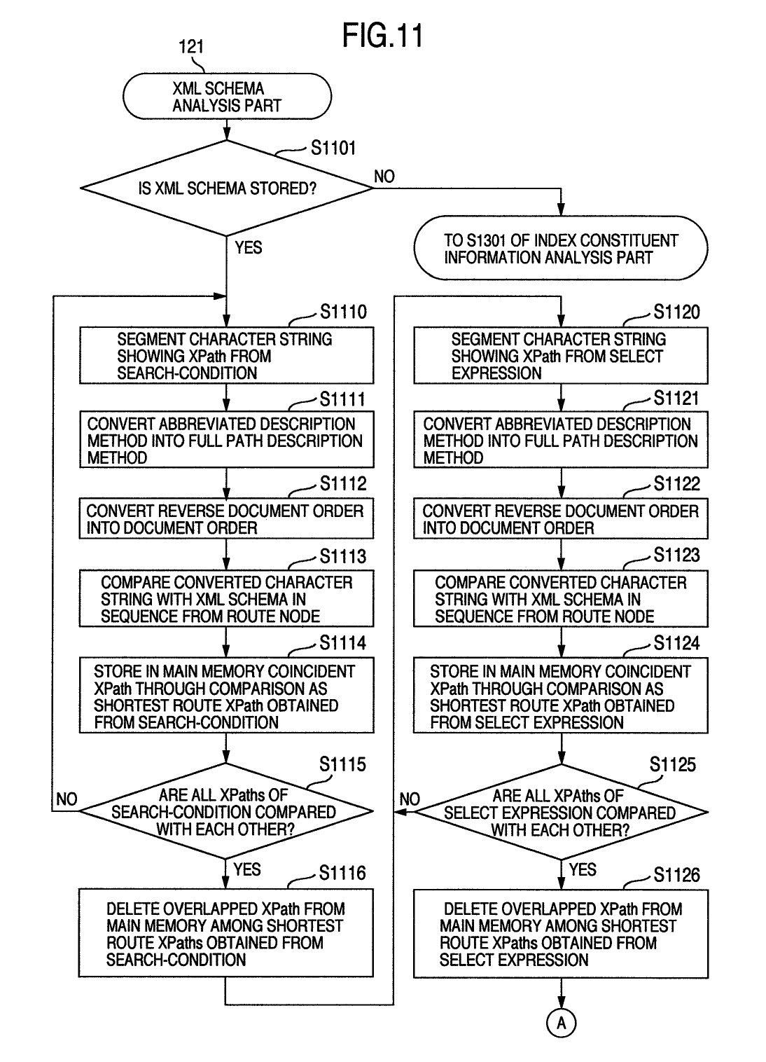

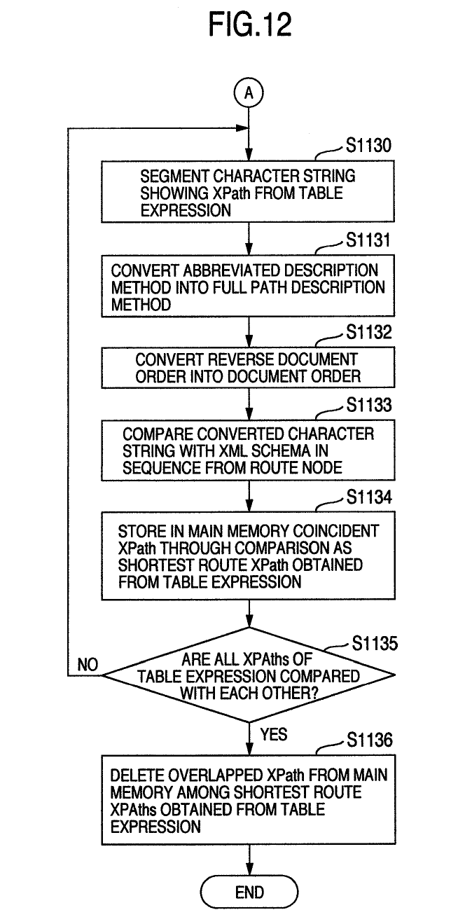

Next, the XML schema analysis part 121 segments a character string showing the XPath specifying a storage position of data to be processed from the select expression 201, table expression 202, search-condition 203 decomposed by the SQL decomposition part 111 (step S704). Continuously, the XML schema analysis part 121 obtains the shortest route XPath from the XPath shown by the character string segmented in step S704 (step S705) (for details, refer to FIGS. 11 and 12 described below). When the segmented character string is specified by the abbreviated description method, the part 121 converts the above description method into the full path description method, and when the character string is specified by the description method of reverse document order, the part 121 converts the above description method into the description method of document order. After that, the part 121 compares each character string with the XML schema 300 stored in the auxiliary storage unit 40. The part 121 stores in the main memory 10 the XPaths that coincide with each other as a result of the comparison as the shortest route XPath 210 obtained from the select expression, the shortest route XPath 220 obtained from the table expression, and the shortest route XPath 230 obtained from the search-condition. In addition, in an example of the supplied SQL statement 200 (see FIG. 2) in FIG. 7, since the character string showing the XPath is absent in the table expression 202, the part 121 does not segment the character string showing the XPath from the table expression 202.

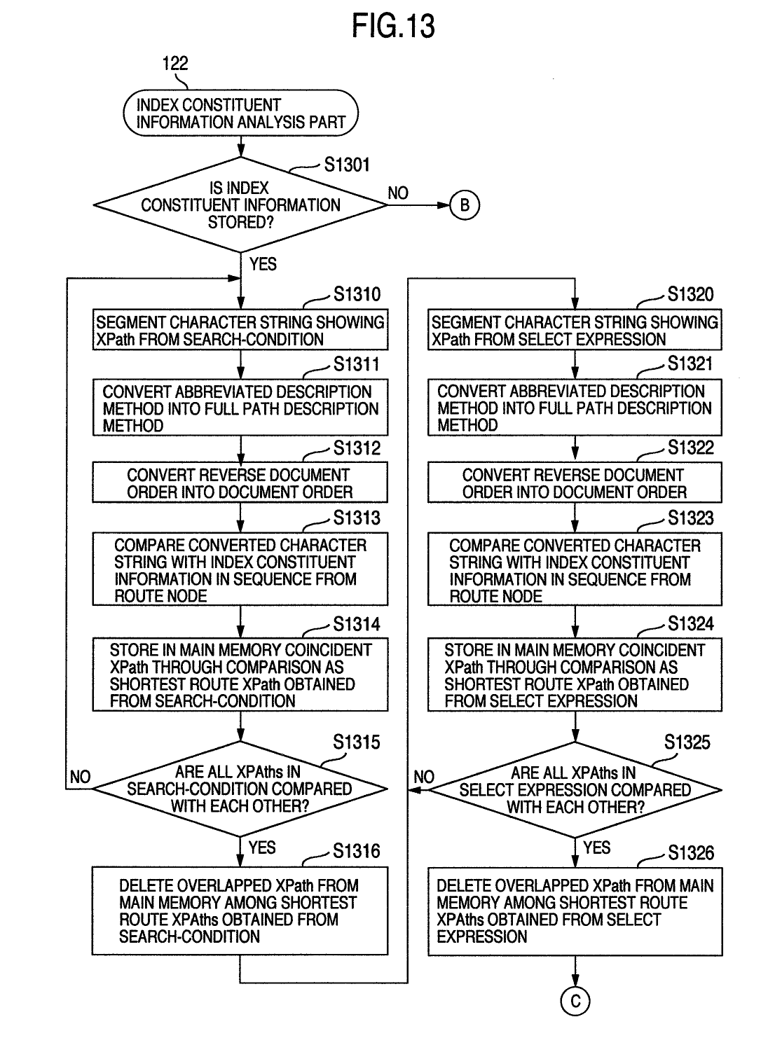

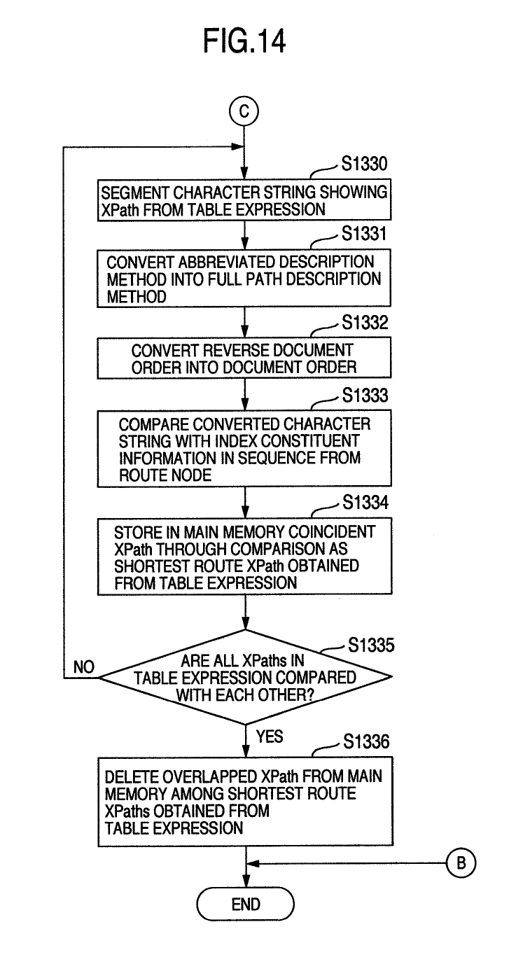

When the XML schema 300 is not stored in the auxiliary storage unit 40, the index constituent information analysis part 122 segments the XPath using the index constituent information 400 stored in the auxiliary storage unit 40 (for details, refer to FIGS. 13 and 14 described below).

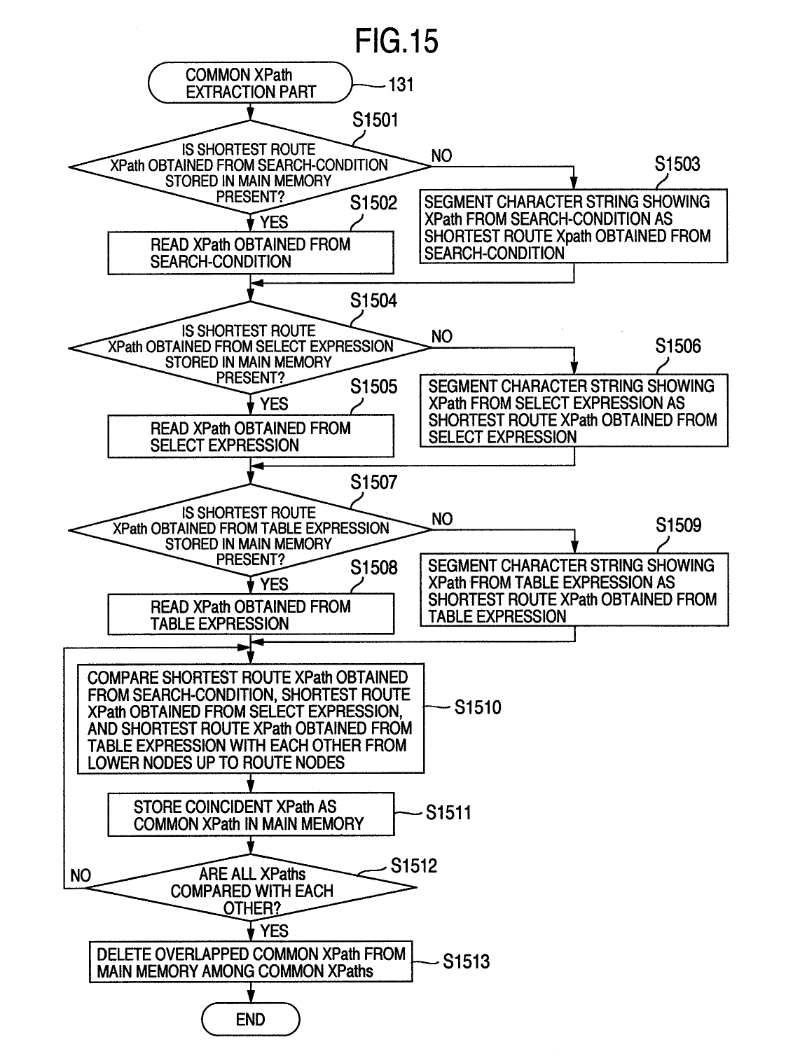

Continuously, the common XPath extraction part 131 extracts the common XPath 250 (step S706) (for details, refer to FIG. 15 described below). The part 131 compares both of the shortest route XPaths obtained by the process of the XML schema analysis part 121 or the index constituent information analysis part 122 from the lower node to the route node. Further, the part 131 stores in the main memory 10 the XPath coincident with each other as a result of the comparison as the common XPath 250. In an example of FIG. 7, the part 131 compares the shortest route XPath 210 obtained from the select expression with the shortest route XPath 230 obtained from the search-condition and extracts as the common XPath 250 the ‘book_info/contents/chapter1’.

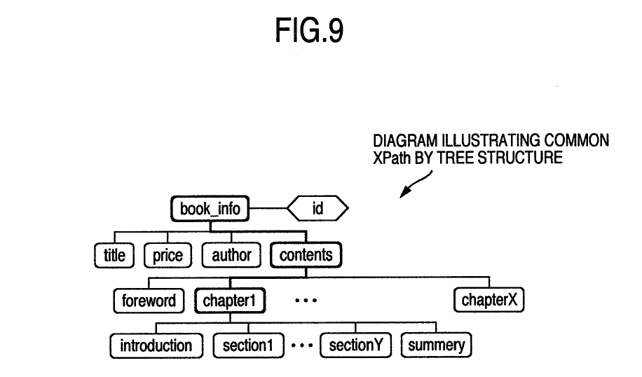

In an example of FIG. 7, FIG. 9 illustrates using the tree structure the common XPath extracted by the common XPath extraction part. As shown in FIG. 9, the common XPath extraction part 131 extracts as the common XPath 250 the ‘book_info/contents/chapter1’ from “book_info” as the route node up to “chapter1” as the path.

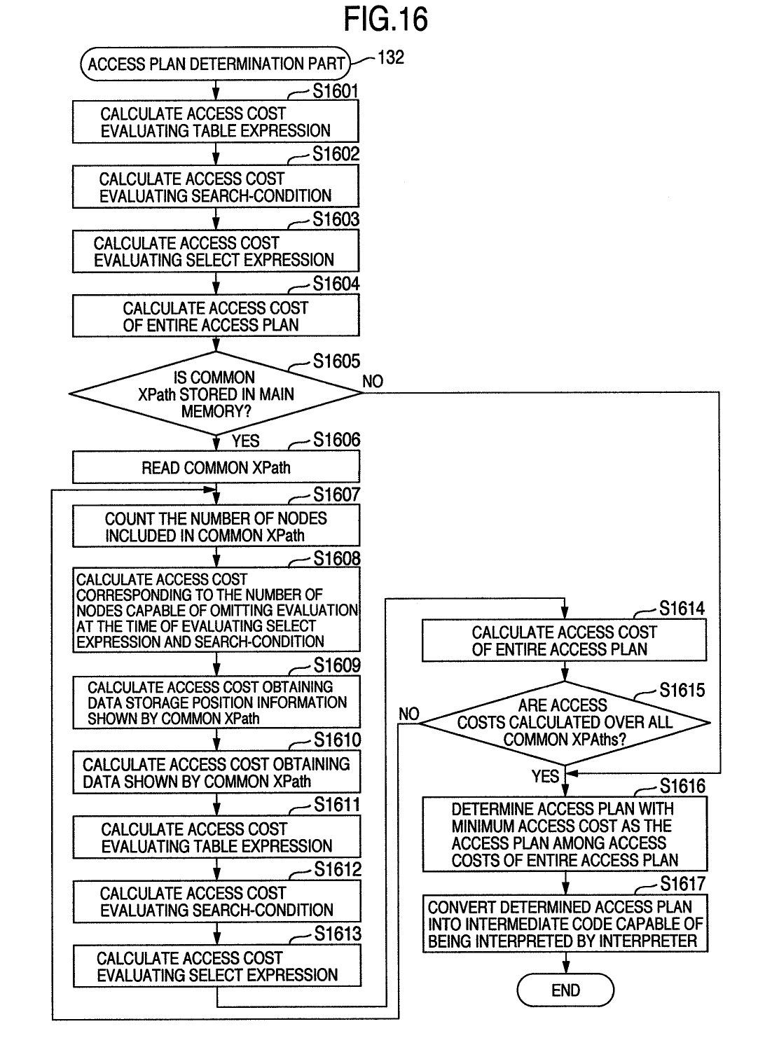

Returning to FIG. 7, the access plan determination part 132 performs an access plan determination process (step S707) (for details, refer to FIG. 16 described below). The part 132 compares one access plan in which the extracted common XPath 250 is used with another access plan in which the common XPath 250 is not used, thereby determining as the access plan an access plan in which the access cost is minimized.

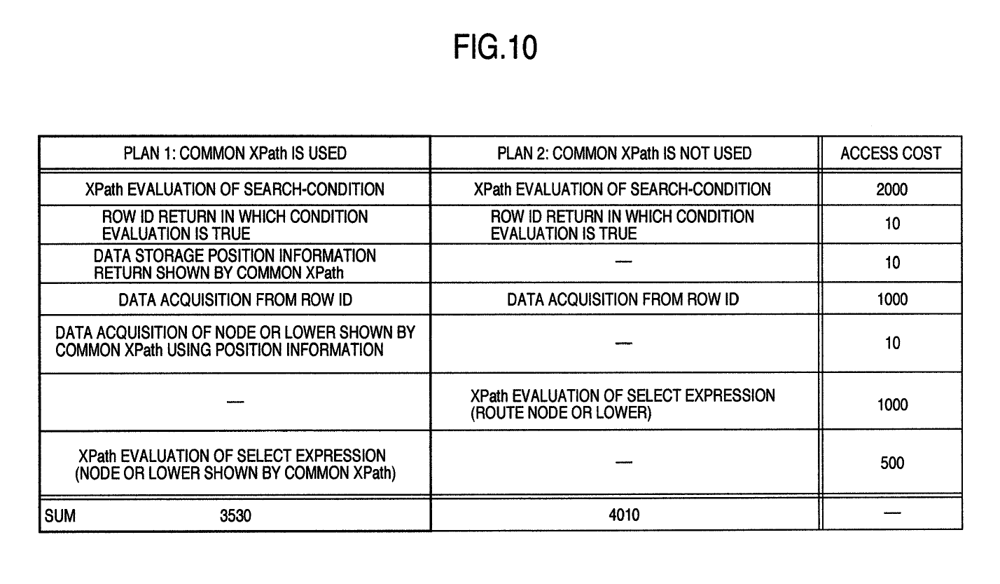

FIG. 10 shows an example where one access plan obtained by calculating a total value of an access cost using the common XPath is compared with another access plan obtained by calculating a total value of an access cost without using the common XPath. Based on the access cost for each process set by the access cost setting information 500 shown in FIG. 5, the access plan determination part 132 calculates one total value of the access cost in the case of using the common XPath 250 and another total value of the access cost in the case of not using the common XPath 250. In an example shown in FIG. 10, the one total value of the access cost in the case (plan 1) of using the common XPath 250 is “3530”, and the another total value of the access cost in the case (plan 2) of not using the common XPath 250 is “4010”. As a result, as the access plan, the part 132 determines an access plan (plan 1) using the common XPath 250, in which the access cost is minimized.

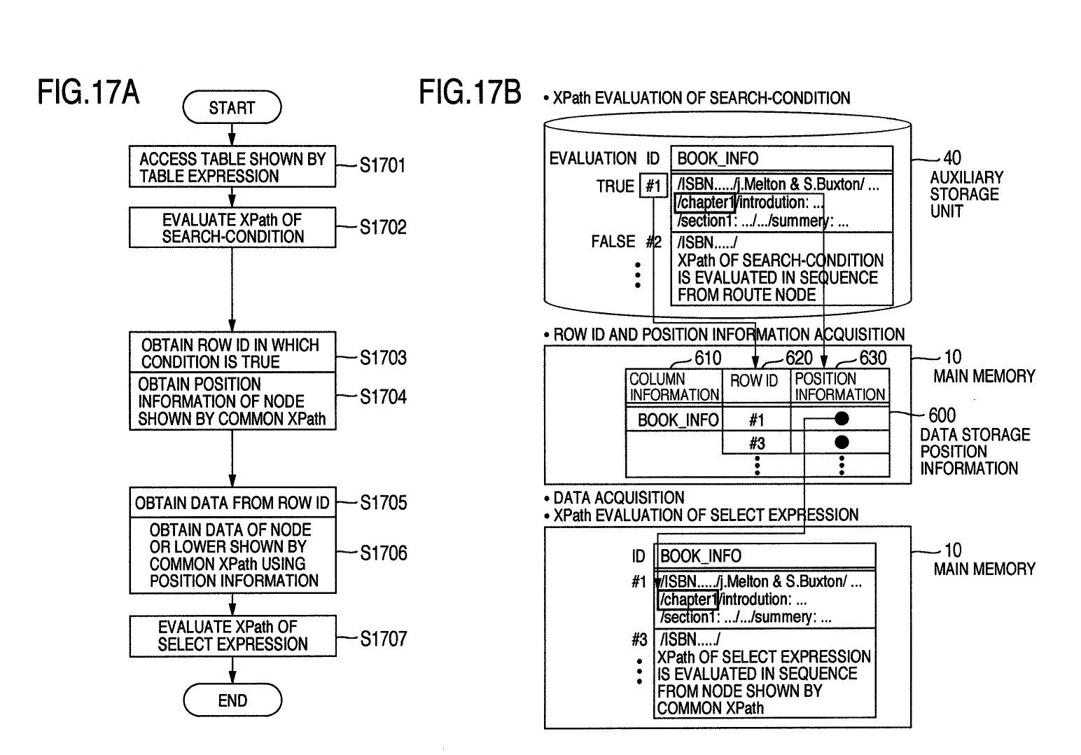

Returning to FIG. 7, based on the access plan determined by the access plan determination part 132, the SQL execution part 140 performs the execution process of the access plan (step S708) (for details, refer to FIGS. 17A to 20 described below).

### (Shortest Route XPath Acquisition Process)

Next, an acquisition process of the shortest route XPath by the XML schema analysis part 121 will be described in detail. In addition, in step shown in FIG. 7, the acquisition process corresponds to processes of steps S704 and S705.

FIGS. 11 and 12 are a flowchart showing a flow at the time when the shortest route XPath is obtained from each of the segmented select expression, table expression, and search-condition by the XML schema analysis part 121 shown in FIG. 1.

As shown in FIG. 11, at first, the XML schema analysis part 121 determines whether the XML schema 300 is stored in the auxiliary storage unit 40 (see FIG. 1) (step S1101). If the XML schema 300 is stored in the auxiliary storage unit 40 (step S1101: Yes), the part 121 segments a character string showing the XPath from the search-condition 203 (step S1110). Next, when the segmented character string is represented using the abbreviated description method, the part 121 converts the above description method into the full path description method (step S1111). Continuously, when the segmented character string is represented by the description method of reverse document order, the part 121 converts the above description method into the description method of document order (step S1112). The part 121 compares the converted XPath and the XML schema 300 from the route node in the order corresponding to the document order (step S1113). Continuously, the part 121 stores in the main memory 10 the XPath coincident with each other through the above-described comparison as the shortest route XPath 230 obtained from the search-condition (step S1114). Next, the part 121 determines whether all the XPaths in the search-condition 203 are compared with the XML schema 300 (step S1115). If the XPath that is not yet compared with the XML schema 300 is present (step S1115: No), the part 121 returns to step S1110 and continues the process. Meanwhile, if all the XPaths in the search-condition 203 are compared with the XML schema 300 (step S1115: Yes), the part 121 goes to step S1116. When the XPath overlaps with each other among the shortest route XPath 230 obtained from the search-condition, the part 121 deletes the overlapped XPath from the main memory 10 (step S1116). In addition, in step S1101, when the XML schema 300 is not stored in the auxiliary storage unit 40 (step S1101: No), the part 121 goes to step S1301 of the index constituent information analysis part 122 in FIG. 13 described below.

Next, the XML schema analysis part 121 segments a character string showing the XPath from the select expression 201 (step S1120). With regard to the character string showing the XPath segmented from the select expression 201, the part 121 performs the same processes (steps S1121 to S1126) as those of steps S1111 to S1116 in the search-condition 203. Further, the part 121 stores in the main memory 10 the XPath coincident with each other through the above-described comparison as the shortest route XPath 210 obtained from the select expression.

Continuously, the XML schema analysis part 121 goes to step S1130 of FIG. 12, and segments the character string showing the XPath from the table expression 202. With regard to the character string showing the XPath segmented from the table expression 202, the part 121 performs the same processes (steps S1131 to S1136) as those of steps S1111 to S1116 in the search-condition 203. Further, the part 121 stores in the main memory 10 the XPath coincident with each other through the above-described comparison as the shortest route XPath 220 obtained from the table expression.

Further, when the index constituent information 400 is stored in the auxiliary storage unit 40, the index constituent information analysis part 122 obtains the shortest route XPath using the index constituent information 400. FIGS. 13 and 14 are a flowchart showing a flow at the time when the shortest route XPath is obtained from each of the segmented select expression, the table expression, and the search-condition by the index constituent information analysis part 122.

At first, the index constituent information analysis part 122 determines whether the index constituent information 400 is stored in the auxiliary storage unit 40 (see FIG. 1) (step S1301). If the index constituent information 400 is stored in the auxiliary storage unit 40 (step S1301: Yes), the part 122 segments a character string showing the XPath from the search-condition 203 (step S1310). Next, when the segmented character string is represented by the abbreviated description method, the part 122 converts the above description method into the full path description method (step S1311). Continuously, when the segmented character string is represented by the description method of reverse document order, the part 122 converts the above description method into the description method of document order (step S1312). The part 122 compares the converted XPath and the index constituent information 400 from the route node in the order corresponding to the document order (step S1313). Continuously, the part 122 stores in the main memory 10 the XPath coincident with each other through the above-described comparison as the shortest route XPath 230 obtained from the search-condition (step S1314). Next, the part 122 determines whether all the XPaths in the search-condition 203 are compared with the index constituent information 400 (step S1315). If the XPath that is not yet compared with the index constituent information 400 is present (step S1315: No), the part 122 returns to step S1310 and continues the process. Meanwhile, if all the XPaths in the search-condition 203 are compared with the index constituent information 400 (step S1315: Yes), the part 122 goes to step S1316. When the XPath overlaps with each other among the shortest route XPath 230 obtained from the search-condition, the part 122 deletes the overlapped XPath from the main memory 10 (step S1316). In addition, in step S1301, if the index constituent information 400 is not stored in the auxiliary storage unit 40 (step S1301: No), the part 122 finishes the process.

Next, the index constituent information analysis part 122 segments a character string showing the XPath from the select expression 201 (step S1320). With regard to the character string showing the XPath segmented from the select expression 201, the part 122 performs the same processes (steps S1321 to S1326) as those of steps S1311 to S1316 in the search-condition 203. Further, the part 122 stores in the main memory 10 the XPath coincident with each other through the above-described comparison as the shortest route XPath 210 obtained from the select expression.

Continuously, the index constituent information analysis part 122 goes to step S1330 of FIG. 14, and segments a character string showing the XPath from the table expression 202. With regard to the character string showing the XPath segmented from the table expression 202, the part 122 performs the same processes (steps S1331 to S1336) as those of steps S1311 to S1316 in the search-condition 203. Further, the part 122 stores in the main memory 10 the XPath coincident with each other through the above-described comparison as the shortest route XPath 220 obtained from the table expression.

### (Common XPath Extraction Process)

Next, a flow in which the common XPath 250 is extracted by the common XPath extraction part 131 and which shows a process of step S706 of FIG. 7 will be described in detail. FIG. 15 is a flowchart showing a flow in which the common XPath is extracted by the common XPath extraction part.

As shown in FIG. 15, at first, the common XPath extraction part 131 determines whether the shortest route XPath 230 obtained from the search-condition stored in the main memory 10 is present (step S1501). If the shortest route XPath 230 obtained from the search-condition stored in the memory 10 is present (step S1501: Yes), the part 131 reads the shortest route XPath 230 obtained from the search-condition (step S1502). If the shortest route XPath 230 obtained from the search-condition stored in the memory 10 is absent (step S1501: No), the part 131 segments the character string showing the XPath from the search-condition 203 as the shortest route XPath 230 obtained from the search-condition 203 (step S1503).

Next, the common XPath extraction part 131 determines whether the shortest route XPath 210 obtained from the select expression stored in the main memory 10 is present (step S1504). If the shortest route XPath 210 obtained from the select expression stored in the main memory 10 is present (step S1504: Yes), the part 131 reads the shortest route XPath 210 obtained from the select expression (step S1505). If the shortest route XPath 210 obtained from the select expression stored in the main memory 10 is absent (step S1504: No), the part 131 segments a character string showing the XPath from the select expression 201 as the shortest route XPath 210 obtained from the select expression (step S1506).

Continuously, the common XPath extraction part 131 determines whether the shortest route XPath 220 obtained from the table expression stored in the main memory 10 is present (step S1507). If the shortest route XPath 220 obtained from the table expression stored in the main memory 10 is present (step S1507: Yes), the part 131 reads the shortest route XPath 220 obtained from the table expression (step S1508). If the shortest route XPath 220 obtained from the table expression stored in the main memory 10 is absent (step S1507: No), the part 131 segments a character string showing the XPath from the table expression 202 as the shortest route XPath 220 obtained from the table expression (step S1509).

The process of segmenting a character string showing the XPath from the search-condition 201, the select expression 202, and the table expression 203 in steps S1503, S1506, and S1509 performed by the common XPath extraction part 131 is a process that is performed in the case where the XML schema 300 and the index constituent information 400 are not stored in the auxiliary storage unit 40. In this connection, when the processes in these steps S1503, S1506, and S1509 are previously set in the common XPath extraction part 131, these steps can be omitted. In this case, in step S1501, if the shortest route XPath 210 obtained from the search-condition stored in the main memory 10 is absent (step S1501: No), for example, the common XPath extraction part 131 does not read the XPath obtained from the search-condition, but goes to the next step S1504. Similarly, if step S1506 of segmenting a character string showing the XPath from the select expression as the character string showing the shortest route is not set, the part 131 goes to the next step S1507. Similarly, when step S1509 of segmenting a character string showing the XPath from the table expression as the character string showing the shortest route is not set, the part 131 goes to the next step S1510.

Next, the common XPath extraction part 131 compares the read XPath 230 obtained from the search-condition, the read XPath 210 obtained from the select expression, and the read XPath 220 obtained from the table expression with each other from the lower nodes up to the route nodes (step S1510). The part 131 stores in the main memory 10 the XPath coincident with each other as the common XPath 250 (step S1511). Continuously, the part 131 determines whether all the shortest route XPaths are compared with each other (step S1512). If the shortest route XPath that is not yet compared with each other is present (step S1512: No), the part 131 returns to step S1510 and continues the process. Meanwhile, if the comparisons of all the shortest route XPaths are finished (step S1512: Yes), the part 131 goes to step S1513. Among the extracted common XPaths 250, the part 131 deletes the overlapped common XPath 250 from the main memory 10.

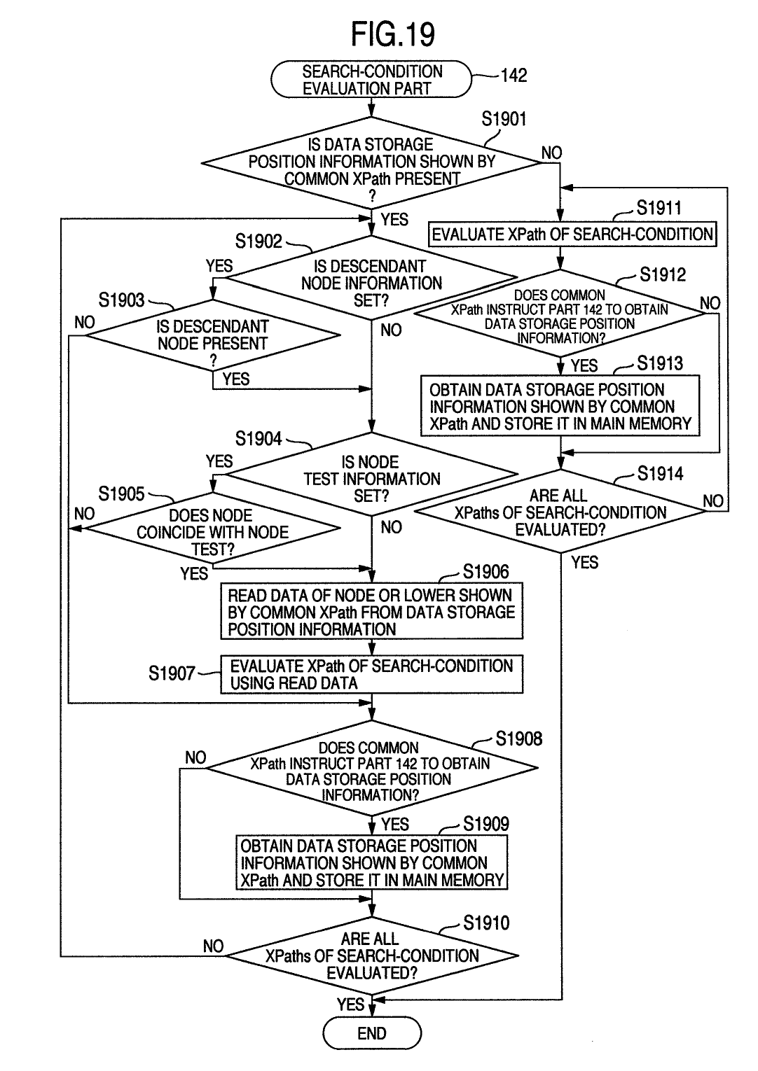

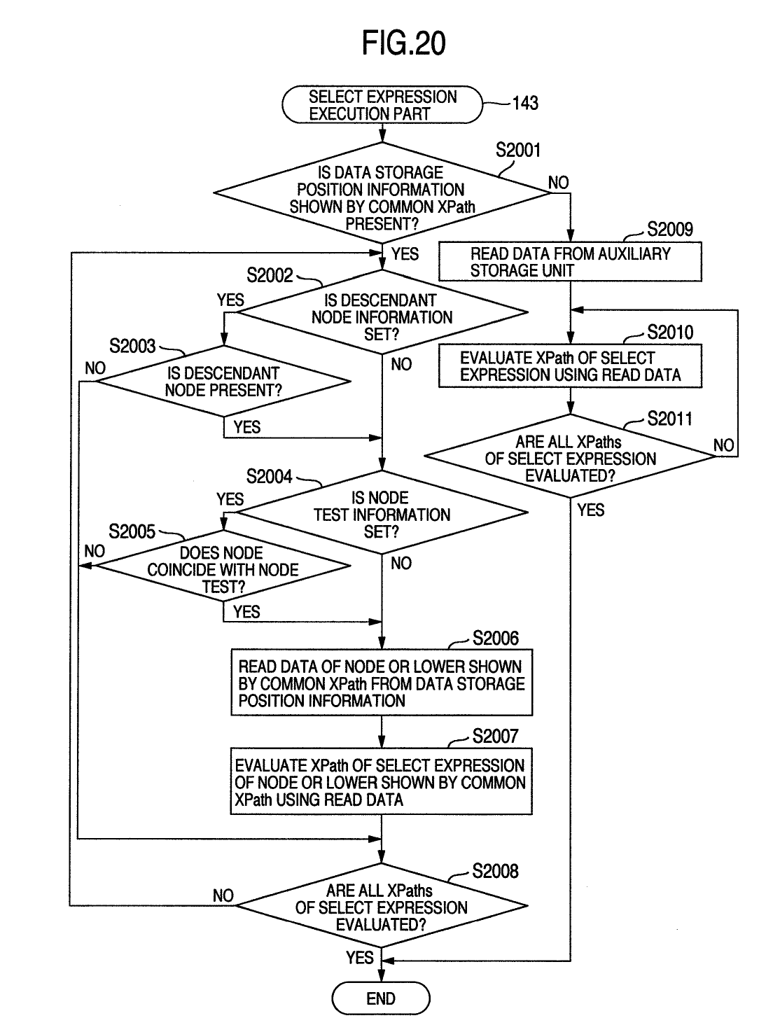

This common XPath 250 is used in order that a path that is evaluated once may be prevented from being evaluated more than once. Accordingly, the common XPath 250 obtained from the table expression is used at the evaluation of the search-condition or select expression which is performed after the evaluation of the table expression (details will be described with reference to FIGS. 19 and 20). The common XPath 250 obtained from the search-condition is used at the evaluation of the select expression which is performed after the evaluation of the search-condition (details will be described with reference to FIG. 20).

### (Character String Comparison of XPath)

A description is thus far made on the case where the common XPath 250 is obtained using the XML schema 300 or the index constituent information 400. However, when the XML schema 300 or the index constituent information 400 is not stored in the auxiliary storage unit 40, the common XPath extraction part 131 segments a character string showing the XPath from the SQL statements and compares the character string with each other, thereby obtaining the common XPath 250.

### (Access Plan Determination Process)

Next, the access plan determination process shown in step S707 of FIG. 7 will be described in detail. FIG. 16 is a flowchart showing a flow at the time when the access plan determination part determines the access plan using the common XPath. The access plan determination part 132 obtains the common XPath 250; and the select expression 201, the table expression 202, and the search-condition 203 resulting from decomposing the SQL statement 200. For the access plan, there are here defined a procedure for performing the XPath evaluation of the table expression, the XPath evaluation of the search-condition, the row ID return, the data storage position information return shown by the common XPath 250, the data acquisition based on the row ID, the data acquisition of nodes or lower shown by the common XPath 250 based on the data storage position information 600, and the XPath evaluation of the select expression.

As shown in FIG. 16, at first, the access plan determination part 132 calculates the access cost for evaluating the table expression (step S1601), the access cost for evaluating the search-condition (step S1602), and the access cost for evaluating the select expression (step S1603). Further, the access plan determination part 132 sums up the respective access costs calculated in steps S1601 to S1603 to calculate the access cost of the entire access plan (step S1604).

Next, the access plan determination part 132 determines whether the common XPaths 250 are stored in the main memory 10 (step S1605). If the common XPaths 250 are stored in the main memory 10 (step S1605: Yes), the part 132 reads the common XPath 250 (step S1606). Continuously, the part 132 counts the number of nodes included in the common XPath 250 (step S1607). The part 132 calculates the access cost corresponding to the number of nodes capable of omitting the evaluation at the time of evaluating the select expression and the search-condition (step S1608). Continuously, the part 132 calculates the access cost for obtaining the data storage position information shown by the common XPath 250 (step S1609). Subsequently, the part 132 calculates the access cost for obtaining the data shown by the common XPath 250 (step S1610). Continuously, the part 132 calculates the access cost for evaluating the table expression (step S1611), the access cost for evaluating the search-condition (step S1612), and the access cost for evaluating the select expression (step S1613).

Next, the access plan determination part 132 sums up the respective access costs calculated in steps S1608 to S1613 to calculate the access cost of the entire access plan (step S1614). Continuously, the part 132 determines whether a process of steps S1607 to S1614 is performed over all the common XPaths 250 (step S1615). If the common XPath 250 that is not yet processed is present (step S1615: No), the part 132 returns to step S1607 and continues the process. Meanwhile, if the access cost is already calculated over all the common XPaths 250 (step S1615: Yes), the part 132 goes to the next step S1616.

On the other hand, in step S1605, when the common XPath 250 is not stored in the main memory 10 (step S1605: No), the access plan determination part 132 goes to the next step S1616. Next, the part 132 determines as the access plan an access plan with the minimum access cost among the respective access costs of the access plans calculated in steps S1604 and S1614 (step S1616). Further, the part 132 converts the determined access plan into an intermediate code capable of being interpreted by an interpreter (step S1617).

The description will be made in detail with reference to an example where the access cost of FIG. 10 is compared with each other. Suppose, for example, that the access plan determination part 132 performs the calculation based on the access cost set in FIG. 5. As shown in FIG. 10, when the access plan is set using the common XPath 250 (plan 1), the part 132 performs the XPath evaluation of the search-condition of “2000”, the row ID return of “10”, the data storage position information return of nodes shown by the common XPath 250 of “10”, the data acquisition from the row ID of “1000”, the data acquisition of nodes or lower shown by the common XPath 250 using the data storage position information of “10”, and the XPath evaluation of the select expression of nodes or lower shown by the common XPath 250 of “500”. As a result, the part 132 sums up all the items to be “3530” as the entire access cost. Meanwhile, when the access plan is set without using the common XPath 250 (plan 2), the part 132 performs the XPath evaluation of the search-condition of “2000”, the row ID return of “10”, the data acquisition from the row ID of “1000”, and the XPath evaluation of the select expression of the route node or lower of “1000”. As a result, the part 132 sums up all the items to be “4010” as the entire access cost. As described above, after comparing a sum of the access costs of the access plan using the common XPath 250 with a sum of the access costs of the access plan without using the common XPath 250, the part 132 determines as the access plan an access plan in which the sum of the access costs is minimized.

### (Access Plan Execution Process)

An access plan execution process shown in step S708 of FIG. 7 will be described in detail.

Based on the access plan determined by the access plan determination part shown in FIG. 1, FIGS. 17A and 17B are conceptual diagrams showing a flow of the entire process in which the SQL execution part performs a process of the SQL statement. FIG. 17A is a flowchart showing a flow of the process that is performed by the database access part, the search-condition evaluation part, and the select expression execution part. FIG. 17B is a conceptual diagram for explaining the process based on practical data corresponding to FIG. 17A. In addition, the description will be here made on the case where the SQL statement 200 shown in FIG. 2 is supplied to the database management apparatus 1 and the ‘book_info/contents/chapter1’ is extracted as the common XPath 250.

As shown in FIG. 17A, at first, the database access part 141 (see FIG. 1) accesses the table (BOOK_TBL) among the XML data fields 700 stored in the auxiliary storage unit 40 (step S1701). Next, the search-condition evaluation part 142 evaluates the search-condition (step S1702). The part 142 obtains the row ID 620 (#1, #3, . . . ) of a row in which the evaluation of the search condition is true (step S1703) and obtains the position information 630 of the node shown by the common XPath 250 (step S1704). Further, the part 142 stores in the memory 10 the data storage position information 600 showing the obtained row ID620 and position information 630.

Next, the select expression execution part 143 obtains data from the row ID620 stored in the data storage position information 600 (step S1705), and develops the data into the main memory 10. The part 143 obtains the data of the nodes or lower shown by the common XPath 250 from the data developed into the main memory 10 using the position information 630 stored in the data storage position information 600 (step S1706). Further, the part 143 does not evaluate the data from the route node up to the nodes shown by the common XPath 250, but evaluates the data of the nodes or lower showing an XPath of the select expression by the common XPath 250 (step S1707).

Next, a description will be made in detail on the flow of the detailed process which is each performed by the database access part 141, the search-condition evaluation part 142, and the select expression execution part 143 in the access plan execution process.

### (Database Access Process)

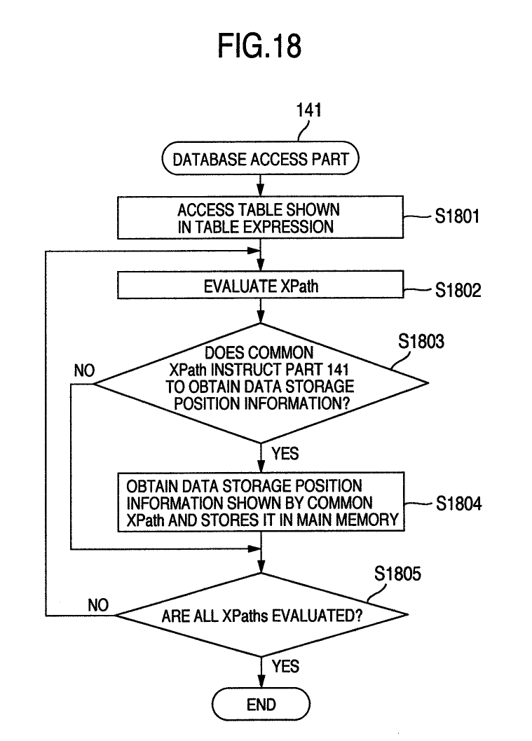

FIG. 18 is a flowchart showing a flow at the time when the database access part of FIG. 1 accesses the database based on the access plan. To the database access part 141, the intermediate code prepared by the access plan determination part 132 is supplied.

As shown in FIG. 18, at first, the database access part 141 accesses a table shown in the table expression 202 (step S1801). Next, the part 141 evaluates the XPath included in the table expression 202 (step S1802). Further, the part 141 determines whether the common XPath 250 instructs the part 141 to obtain the data storage position information 600 (step S1803). If the common XPath 250 instructs the part 141 to obtain the data storage position information 600 (step S1803: Yes), the part 141 obtains the data storage position information 600 shown by the common XPath 250 and stores the information 600 in the main memory 10 (step S1804). Meanwhile, if the common XPath 250 does not instruct the part 141 to obtain the data storage position information 600 (step S1803: No), the part 141 does not obtain the data storage position information 600 shown by the common XPath 250, but goes to step S1805. The part 141 determines whether all the XPaths in the table expression 202 are evaluated (step S1805). If the XPath that is not yet evaluated in the table expression 202 is present (step S1805: No), the part 141 returns to step S1802 and continues the process. If all the XPaths are evaluated in the table expression 202 (step S1805: Yes), the part 141 finishes the process. In addition, when the XPath is absent in the table expression 202, the part 141 performs only a process of step S1801.

The data storage position information 600 shown by the common XPath 250 obtained in step S1804 by the database access part 141 is used by the search-condition evaluation part 142 or the select expression execution part 143. The data storage position information 600 (in step S1907 or S1911 of FIG. 19 described below) shown by the common XPath 250, obtained by the search-condition evaluation part 142 is used by the select expression execution part 143. The search-condition evaluation part 142 and the select expression execution part 143 do not necessarily use the same data storage position information 600, and the access plan determination part 132 determines the information 600 such that the access cost is minimized.

### (Search-Condition Evaluation Process)

FIG. 19 is a flowchart showing a flow at the time when the search-condition evaluation part of FIG. 1 evaluates the search-condition based on the access plan. To the search-condition evaluation part 142, data accessed by the database access part 141 and the data storage position information 600 stored in the main memory 10 are supplied.

As shown in FIG. 19, at first, the search-condition evaluation part 142 determines whether the data storage position information 600 (see FIG. 6) shown by the common XPath 250, obtained by the database access part 141 is present (step S1901). The case where the data storage position information 600 is present (step S1901: Yes) here means the case where the XPath is included in the table expression and the common XPath 250 can be extracted from the XPath of the table expression and the XPath of the search-condition. In this connection, even if the common XPath 250 is extracted, when the access cost is not minimized, the access plan without the data storage position information 600 may be determined.

The search-condition evaluation part 142, when the data storage position information 600 is present (step S1901: Yes), next determines whether descendant node information 640 (see FIG. 6B) is set in the data storage position information 600 (step S1902). If the descendant node information 640 is not set in the data storage position information 600 (step S1902: No), the part 142 goes to step S1904. Meanwhile, if the descendant node information 640 is set in the data storage position information 600 (step S1902: Yes), the part 142 goes to step S1903. Based on the descendant node information 640, the part 142 determines whether a descendant node is present (step S1903). Based on the descendant node information 640, if the part 142 here determines that the descendant node is absent (step S1903: No), the part 142 goes to step S1908 without reading data. Meanwhile, based on the descendant node information 640, if the part 142 determines that the descendant node is present (step S1903: Yes), the part 142 goes to step S1904.

As described above, when the descendant node information 640 is set in the data storage position information 600, in the case where the descendant node is absent based on the descendant node information 640 (step S1903: No), data on the descendant node of the node or lower specified by the common XPath 250 is not read in the process of the search-condition, and therefore, the search time can be shortened.

Next, the search-condition evaluation part 142 determines whether the node test information 650 (see FIG. 6B) is set in the data storage position information 600 (step S1904). If the node test information 650 is not set in the data storage position information 600 (step S1904: No), the part 142 goes to step S1906. Meanwhile, if the node test information 650 is set in the data storage position information 600 (step S1904: Yes), the part 142 goes to step S1905. Based on the node test information 650, the part 142 determines whether the node shown by the common XPath 250 coincides with the node test (step S1905). Based on the node test information 650, if the part 142 here determines that the node does not coincide with the node test (step S1905: No), the part 142 goes to step S1908 without reading data. Meanwhile, based on the node test information 650, if the part 142 determines that the node coincides with the node test (step S1905: Yes), the part 142 goes to step S1906.

As described above, when the node test information 650 is set in the data storage position information 600, in the case where the node shown by the common XPath 250 does not coincide with the node test 650 (step S1905: No), the data shown by the node is not read in the process of the search-condition, and therefore, the search time can be shortened.

Next, in step S1906, the search-condition evaluation part 142 reads the data of the node or lower shown by the common XPath 250 from the data storage position information 600 (step S1906). The part 142 evaluates the search-condition using the read data (step S1907). Continuously, the part 142 determines whether the common XPath 250 instructs the part 142 to obtain the data storage position information 600 (step S1908). If the common XPath 250 instructs the part 142 to obtain the data storage position information 600 (step S1908: Yes), the part 142 obtains the data storage position information 600 and stores the information 600 in the main memory 10 (step S1909). Meanwhile, if the common XPath 250 does not instruct the part 142 to obtain the data storage position information 600 (step S1908: No), the part 142 goes to step S1910. Continuously, the part 142 determines whether all the search-conditions are evaluated (step S1910). If the search-condition that is not yet evaluated is present (step S1910: No), the part 142 returns to step S1902 and continues the process. Meanwhile, if all the search-conditions are evaluated (step S1910: Yes), the part 142 finishes the process.

On the other hand, in step S1901, if the data storage position information 600 shown by the common XPath 250, obtained by the database access part 141 is absent (step S1901: No), the part 142 evaluates the search-condition without using the common XPath 250 (step S1911). Next, the part 142 determines whether the common XPath 250 instructs the part 142 to obtain the data storage position information 600 (step S1912). If the common XPath 250 instructs the part 142 to obtain the data storage position information 600 (step S1912: Yes), the part 142 obtains the data storage position information 600 and stores the information 600 in the main memory 10 (step S1913). Meanwhile, if the common XPath 250 does not instruct the part 142 to obtain the data storage position information 600 (step S1912: No), the part 142 goes to step S1914. Continuously, the part 142 determines whether all the search-conditions are evaluated (step S1914). If the search-condition that is not yet evaluated is present (step S1914: No), the part 142 returns to step S1911 and continues the process. Meanwhile, if all the search-conditions are evaluated (step S1914: Yes), the part 142 finishes the process.

### (Select Expression Evaluation Process)

FIG. 20 is a flowchart showing a flow at the time when the select expression execution part of FIG. 1 evaluates the XPath of the select expression based on the access plan. To the select expression execution part 143, the data storage position information 600 stored in the main memory 10 by the database access part 141 or the search-condition evaluation part 142 is supplied.

As shown in FIG. 20, at first, the select expression execution part 143 determines whether the data storage position information 600 shown by the common XPath 250, obtained by the database access part 141 or the search-condition evaluation part 142 is present (step S2001).

The case where the data storage position information 600 is present (step S2001: Yes) here means the following three cases: (1) a case where an XPath is included in the table expression 202 and the common XPath 250 can be extracted from the above XPath and the XPath included in the select expression 201, (2) a case where an XPath is included in the search-condition 203 and the common XPath 250 can be extracted from the above XPath and the XPath included in the select expression 201, and (3) a case where one XPath is included in the table expression 202 and another XPath is included also in the search-condition 203, and the common XPath 250 can be extracted from the above XPaths and the XPath included in the select expression 201. Among the three cases, the common XPath 250 to be used is determined based on the access plan determined by the access plan determination part 132. Accordingly, even if the common XPath 250 is extracted, when the access cost is not minimized, the access plan without the data storage position information 600 may be determined.

Returning to FIG. 20, when the data storage position information 600 shown by the common XPath 250 is present (step S2001: Yes), the select expression execution part 143 next determines whether the descendant node information 640 (see FIG. 6B) is set in the data storage position information 600 (step S2002). If the descendant node information 640 is not set in the data storage position information 600 (step S2002: No), the part 143 goes to step S2004. Meanwhile, if the descendant node information 640 is set in the data storage position information 600 (step S2002: Yes), the part 143 goes to step S2003. Based on the descendant node information 640, the part 143 determines whether the descendant node is present (step S2003). Based on the descendant node information 640, if the part 143 here determines that the descendant node is absent (step S2003: No), the part 143 goes to step S2008 without reading data. Meanwhile, based on the descendant node information 640, if the part 143 determines that the descendant node is present (step S2003: Yes), the part 143 goes to step S2004.

As described above, when the descendant node information 640 is set in the data storage position information 600, in the case where the descendant node is absent based on the descendant node information 640 (step S2003: No), data on the descendant node of the node or lower specified by the common XPath 250 is not read in the process of the select expression, and therefore, the search time can be shortened.

Next, the select expression execution part 143 determines whether the node test information 650 (see FIG. 6B) is set in the data storage position information 600 (step S2004). If the node test information 650 is not set in the data storage position information 600 (step S2004: No), the part 143 goes to step S2006. Meanwhile, if the node test information 650 is set in the data storage position information 600 (step S2004: Yes), the part 143 goes to step S2005. Based on the node test information 650, the part 143 determines whether the node shown by the common XPath 250 coincides with the node test (step S2005). Based on the node test information 650, if the part 143 here determines that the node does not coincide with the node test (step S2005: No), the part 143 goes to step S2008 without reading data. Meanwhile, based on the node test information 650, if the part 143 determines that the node coincides with the node test (step S2005: Yes), the part 143 goes to step S2006.

As described above, when the node test information 650 is set in the data storage position information 600, in the case where the node shown by the common XPath 250 does not coincide with the node test 650 (step S2005: No), the data shown by the node is not read in the process of the select expression, and therefore, the search time can be shortened.

Next, in step S2006, the select expression execution part 143 reads data on the node or lower shown by the common XPath 250 from the data storage position information 600 (step S2006). Next, using the read data, the part 143 evaluates the XPaths of the select expressions of the node or lower shown by the common XPath 250 (step S2007). Continuously, the part 143 determines whether all the XPaths of the select expression are evaluated (step S2008). If the XPath of the select expression which is not yet evaluated is present (step S2008: No), the part 143 returns to step S2002 and continues the process. Meanwhile, if all the XPaths of the select expression are evaluated (step S2008: Yes), the part 143 finishes the process.

On the other hand, in step S2001, if the data storage position information 600 shown by the common XPath 250, obtained by the database access part 141 or the search-condition evaluation part 142 is absent (step S2001: No), the select expression execution part 143 reads the XML data 700 from the auxiliary storage unit 40 (step S2009). Continuously, the part 143 evaluates the XPaths of the select expression using the read data (step S2010). Next, the part 143 determines whether all the XPaths of the select expression are evaluated (step S2011). If the XPath of the select expression which is not yet evaluated is present (step S2011: No), the part 143 returns to step S2010 and continues the process. Meanwhile, if all the XPaths of the select expression are evaluated (step S2011: Yes), the part 143 finishes the process.

As a result, the database management method, database management apparatus, and program according to the present embodiment can eliminate a process from the route nodes up to the nodes shown by the common path and shorten the search time of the structured data.

It should be further understood by those skilled in the art that although the foregoing description has been made on embodiments of the invention, the invention is not limited thereto and various changes and modifications may be made without departing from the spirit of the invention and the scope of the appended claims.

1. A database management method for processing structured data using an SQL (Structured Query Language) by a database management apparatus comprising a storage part for storing one or more databases storing the structured data and a database management part for managing the databases stored in the storage part, wherein:
the database management part obtains an SQL statement for processing the structured data, and
extracts, from the obtained SQL statement, all paths showing a storage position of data to be processed among the structured data fields,
when a plurality of the paths are extracted, the database management part compares each of the extracted paths with a schema of the structured data stored in the storage part in sequence from a route node up to a storage position of the data to be processed shown by each of the extracted paths,
obtains paths of routes from the route node in each of the extracted paths up to the storage position of the data to be processed,
compares the obtained paths of the routes with each other, and extracting as a common path a common part of both the paths of the routes, and
processes, by using the SQL, the data of nodes of the storage position or lower shown by the extracted common path in the structured data stored in the storage part.

2. The database management method according to claim 1, wherein:
the database management part, when each of the extracted paths is specified by an abbreviated description method, converts the description method into a full path description method; and
when each of the paths specified by the full path description method is specified by a description method of reverse document order, the database management part converts the description method into a description method of document order.

3. The database management method according to claim 2, wherein:
the SQL statement includes at least a table expression specifying the structured data to be processed and a select expression projecting data including predetermined elements among the structured data fields specified by the table expression,
the database management part decomposes the SQL statement at least into the table expression and the select expression, and
extracts a path showing a storage position of the data to be processed from each of the decomposed table expression and the decomposed select expression,
when a plurality of the paths are extracted, the database management part compares each of the extracted paths and a schema of the structured data stored in the storage part in sequence from the route node up to a storage position of the data to be processed shown by each of the extracted paths,
obtains a path of a route from the route node at least in each of the table expression and the select expression,
compares at least the obtained path of the route of the table expression with the obtained path of the route of the select expression, and
extracts a common part of the path of the route as the common path.

4. The database management method according to claim 3, wherein:
the database management part counts the number of nodes included in each of the one or more extracted common paths, calculates an access cost corresponding to the number of nodes capable of omission at the time of processing the structured data at least in each of the table expression and the select expression, and determines an access plan so as to minimize the access cost; and
accesses the structured data specified by the table expression according to the determined access plan, and projects the data that coincides with the select expression onto the data of the node of the storage position or lower to be processed shown by the common path.

5. The database management method according to claim 4, wherein:
the database management part stores, in the storage part, data storage position information including a storage position of the data to be processed shown by the common path and information showing the presence or absence of descendant node as a lower node in the structured data of the node shown by the common path; and
the database management part does not process the data of nodes of the storage position or lower to be processed shown by the common path when determining, based on the data storage position information, that the descendant node is absent.

6. The database management method according to claim 5, wherein:
the data storage position information further includes information showing whether a node shown by paths showing a storage position of the data to be processed at least in the select expression coincides with a predetermined node test; and
the database management part does not process data of the node when the node does not coincide with the predetermined node test.

7. The database management method according to claim 1, wherein:
the database management part determines, according to the hint information, whether a process is performed using the common path when hint information specifying whether a process is performed using the common path is included in the SQL statement.

8. The database management method according to claim 1, wherein:
the database management part obtains hint information specifying whether a process is performed using a common path in units of an application, or hint information specifying whether a process is performed using a common path in units of a database management system, and determines, according to the hint information, whether a process is performed using the common path.

9. The database management method according to claim 1, wherein:
the database management part, when index definition information of an index specifying a storage position of the structured data is stored in the storage part, compares each path showing a storage position of the data to be processed with a path showing a storage position of the structured data specified by an index key shown by the index definition information stored in the storage part in sequence from the route node up to the storage position of the structured data specified by the index key, and obtains a character string of the route from the route node in each path showing the storage position of the data to be processed.

10. The database management method according to claim 1, wherein:
the database management part, when both of the schema of the structured data and the index definition information specifying the storage position of the structured data are not stored in the storage part, extracts all paths showing the storage position of the data to be processed among the structured data fields from the obtained SQL statement, and extracts as the common path a common part obtained by comparing the extracted paths with each other.

11. A database management apparatus including a communication part for receiving a processing request from the outside via a communication line, a storage part for storing one or more databases storing structured data, and a database management part for managing the databases, wherein:
the database management part obtains via the communication part an SQL statement for processing the structured data stored in the storage part, and
extracts, from the obtained SQL statement, all paths showing a storage position of data to be processed among the structured data fields,
when a plurality of the paths are extracted, the database management part compares each of the extracted paths with a schema of the structured data stored in the storage part in sequence from a route node up to a storage position of the data to be processed shown by each of the extracted paths,
obtains paths of routes from the route node in each of the extracted paths up to the storage position of the data to be processed,
compares the obtained paths of the routes with each other, and extracts as a common path a common part of both the paths of the routes, and
processes, by using the SQL statement, the data of nodes of the storage position or lower shown by the extracted common path in the structured data stored in the storage part.

12. A program for causing a computer to execute the database management method according to claim 1.
